(19) United States
(12) Patent Application Publication
(10) Pub. No.: US 2005/0010476 A1
(43) Pub. Date: Jan. 13, 2005

(54) Consumer specific marketing tool method and apparatus

(75) Inventor: Matthew William Combs, Frisco, TX (US)

Correspondence Address: CARR LAW FIRM, L.L.P., 670 FOUNDERS SQUARE, 900 JACKSON STREET, DALLAS, TX, 75202, US

(73) Assignee: Nubella, Inc., Dallas, TX (US)

(21) Appl. No.: 10/737,577

(22) Filed: Dec. 16, 2003

Related U.S. Application Data
(60) Provisional application No. 60/485,269, filed on Jul. 7, 2003.

(51) Int. Cl. G06F 17/60

(52) U.S. Cl. 705/14; 705/10

(57) ABSTRACT

Disclosed is a health related method and apparatus for collecting, collating and filtering information, related to specific individuals and/or their families, obtained from purchases made in conjunction with product source shopper loyalty program cards. Authorization for the collection of the information is made in advance of the collection. An analysis of the collected information is used to provide a health related report, specific to a given individual or family, of deficiencies in the recipient's diet and/or medicine. The total collected information may be subdivided into groups of entities having certain commonalities. Accompanying the report, coupons are provided for products that are known to be beneficial to correcting health related deficiencies and attributes, for a commonality group of consumers, as well as health related educational material for helping the recipient ascertain which health related products should next be purchased. In addition, the material may provide educational material to inform the consumer about health in general, healthy food preparation recipes, the advertised products specifically, the health benefits relating to types of advertised products and detailed nutritional value listing of advertised products as may be found of the product packages.

### CLAIM OF PRIORITY

This application claims priority from U.S. Provisional Patent Application No. 60/485,269 of Matthew W. Combs entitled “DATA INTERCHANGE METHOD AND APPARATUS” filed Jul. 7, 2003, which application is incorporated herein by reference.

### TECHNICAL FIELD

The invention relates to a method for collecting food purchase data to provide consumer specific nutritional information.

### BACKGROUND

Most consumers of food products do not have, and/or may not know how to get, sufficient information to make healthy food purchases. Many do not know how to ascertain what quantities of nutrients are contained in the food they purchase from nutrient information included on most prepackaged food products.

Many stores presently have customer benefit cards (or loyalty cards) that allow a consumer to purchase some shelf items at a discount from what they would otherwise pay. Additional inducements are sometimes provided, such as air miles that are awarded based upon purchases made by the consumer. However, these and other benefits typically provided to loyalty card holders do not assist the customer in making informed decisions about the nutritional and health value of the food products being considered for purchase.

A need therefore exists for a method and system for tracking individual consumers' food purchases, compiling the types and quantities of nutrients found within these purchases and informing subscribing consumers as to how their purchases compare to one or more guidelines. A need also exists for a method and system for informing the consumer of food products that can be purchased to correct indicated discrepancies between actual nutrient purchases and, for example, nutrient consumption recommended by known authorities. A further need exists for a method and system of simultaneously informing the consumer of specific products for purchase to help fulfill nutrient needs.

### SUMMARY OF THE INVENTION

The present invention comprises a method and system for providing information and incentives to a consumer for the purchase of certain products, by referencing or providing to the consumer at least one nutrition related component of data reflecting existing or prior purchases by the consumer, information about alternate products helpful to the consumer, discounts available for alternate products helpful to the consumer and guidelines for comparison with any of the forgoing data.

### BRIEF DESCRIPTION OF THE DRAWINGS

For a more complete understanding of the present invention, and its advantages, reference will now be made in the following Detailed Description to the accompanying drawings, in which:

FIG. 1 is a generalized block diagram of the components involved in implementing the present system;

FIG. 2 is a high level block diagram of the steps involved in FIG. 1 for implementing a method for collecting data, comparing the data obtained with known standards and generating consumer specific material for presentation to consumers;

FIGS. 3A and 3B provide a more detailed presentation of the flow diagram of FIG. 2;

FIG. 4 provides an illustration of one example of a packet of consumer-specific purchasing information that may be presented to a consumer, also comprising one or more discount entitlement coupons or tokens redeemable by the consumer;

FIG. 5 illustrates the contents of a portion of a bill of health (BOH) invention, comprising consumer-specific information related to purchases by the consumer; and

FIG. 6 is a graph illustrating the sources of a nutrient.

### DETAILED DESCRIPTION

In this description, a processing unit (PU) may be a sole processor of computations in a device. In such a situation, the PU is typically referred to as a CPU (central processing unit).

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electrical or electro-magnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

As indicated above, the invention comprises a method of collecting and processing data related to food purchases by individuals and/or their families. The data collected is then provided in a preferred form to a given consumer. In a preferred embodiment, the data is tailored to either general attributes (e.g., age, gender, etc.) or specific attributes (e.g., diabetic, overweight, heart condition, etc.) of the individual.

In a preferred embodiment, the data is presented in the form of a BOH (bill of health), along with entitlement coupons, health/food related information and so forth. In a preferred embodiment, the BOH and accompanying information comprises a single collection of information (possibly via email, web page, or other electronic delivery) or pamphlet (printed or hard copy) for each consumer in the system. Each collection of information or pamphlet will be unique, in that some of the information will be very specific to each consumer. A cost-effective approach is to prepare a collection of information or a pamphlet that is “group specific” and insert or otherwise add consumer specific information to the collection of information or pages to the pamphlet.

As an example of “group specific” as used in the paragraph above, every participating consumer who is a diabetic would receive the same collection of information or pamphlet. Each consumer would also receive additional information or pages detailing information specific to that consumer, such as consolidated nutrient information pertaining to purchases made by that consumer in a recent time period such as the preceding month. The additional information or pages could also inform the consumer of nutrient deficiencies that may be occurring, in view of the data collected. It will be realized that all consumers in any “group,” such as diabetics for example, will not be the same. For example, some members of the group may have a high blood pressure condition. In such a situation, the additional information and pages could comprise additional information, pages, coupons and/or the like related to products that can help control high blood pressure.

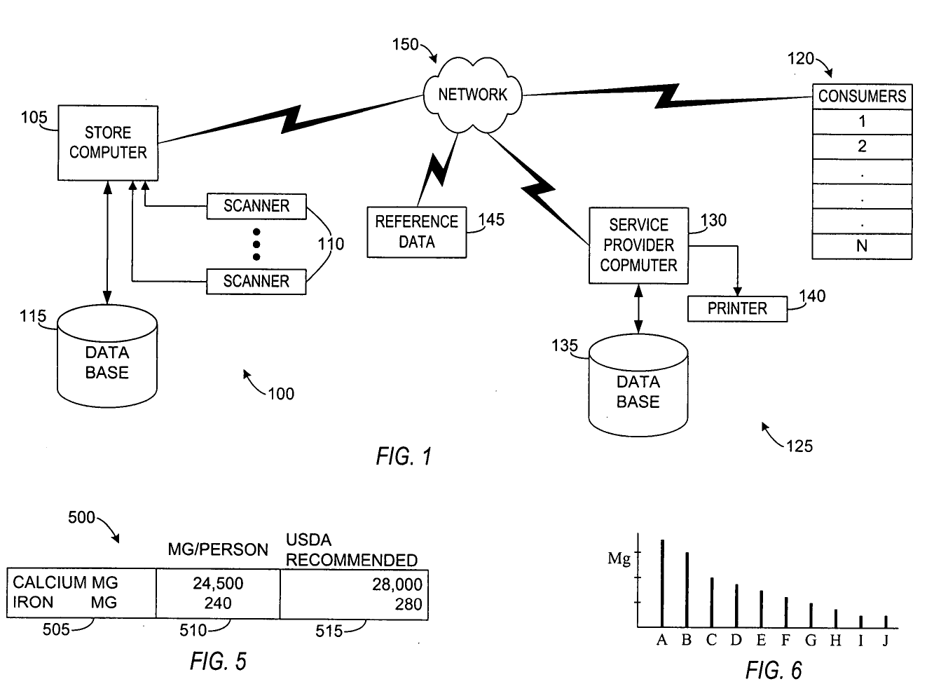

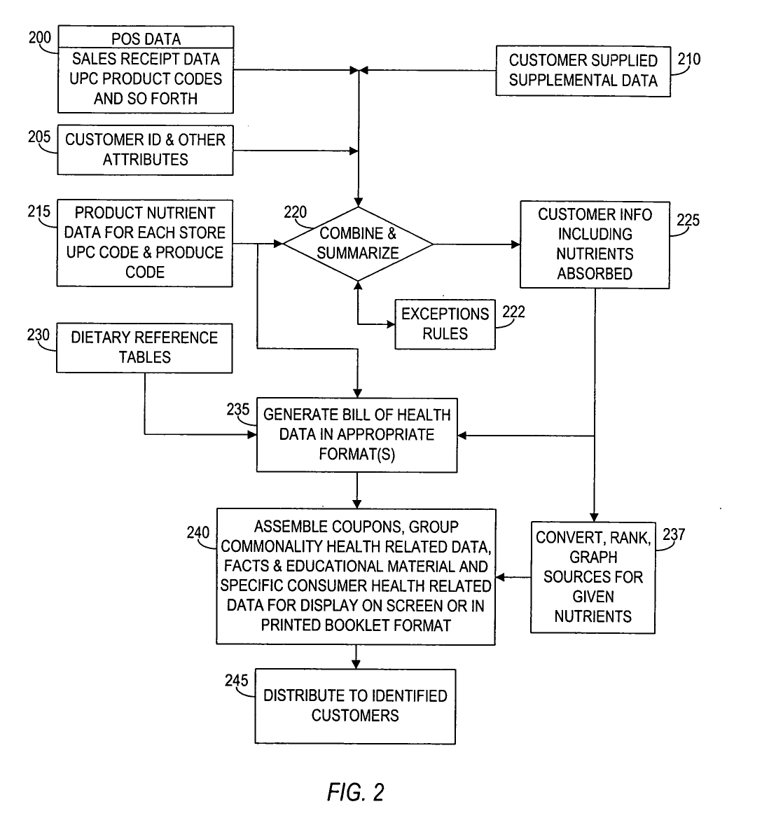

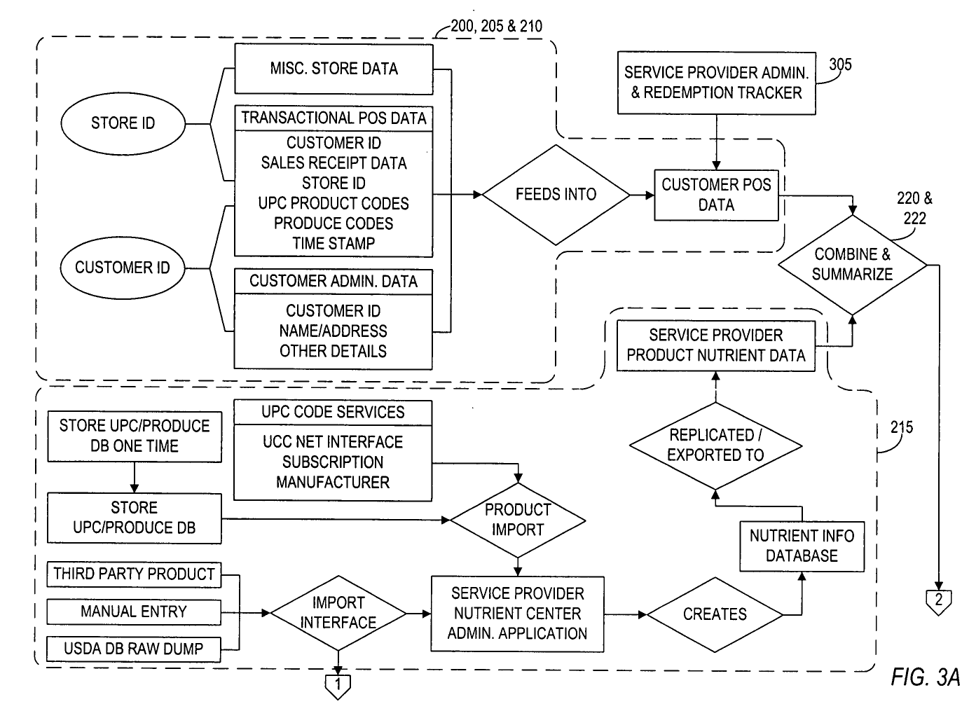

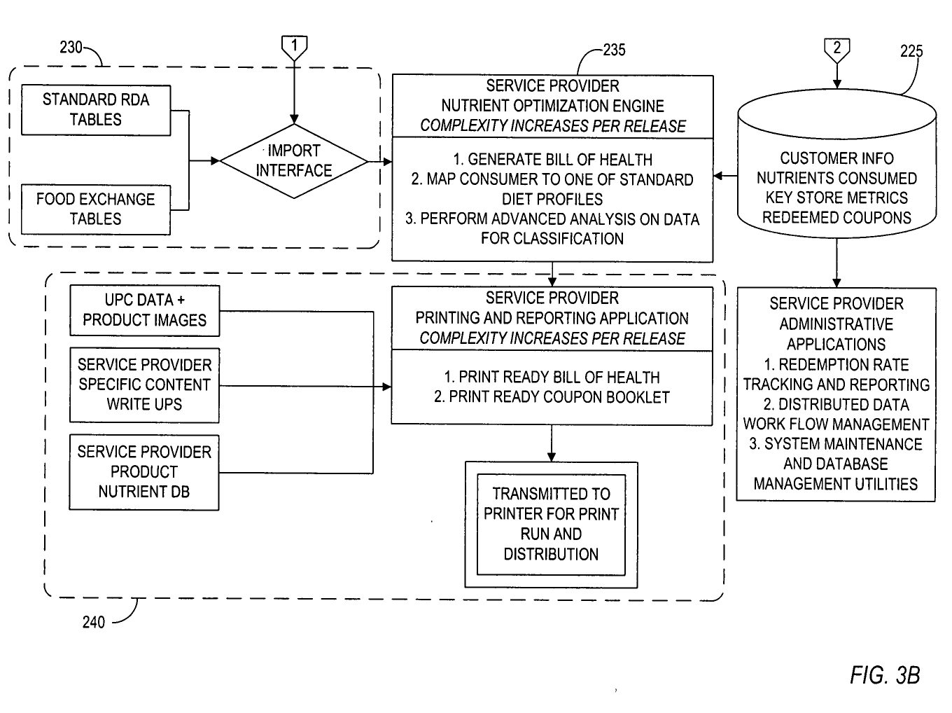

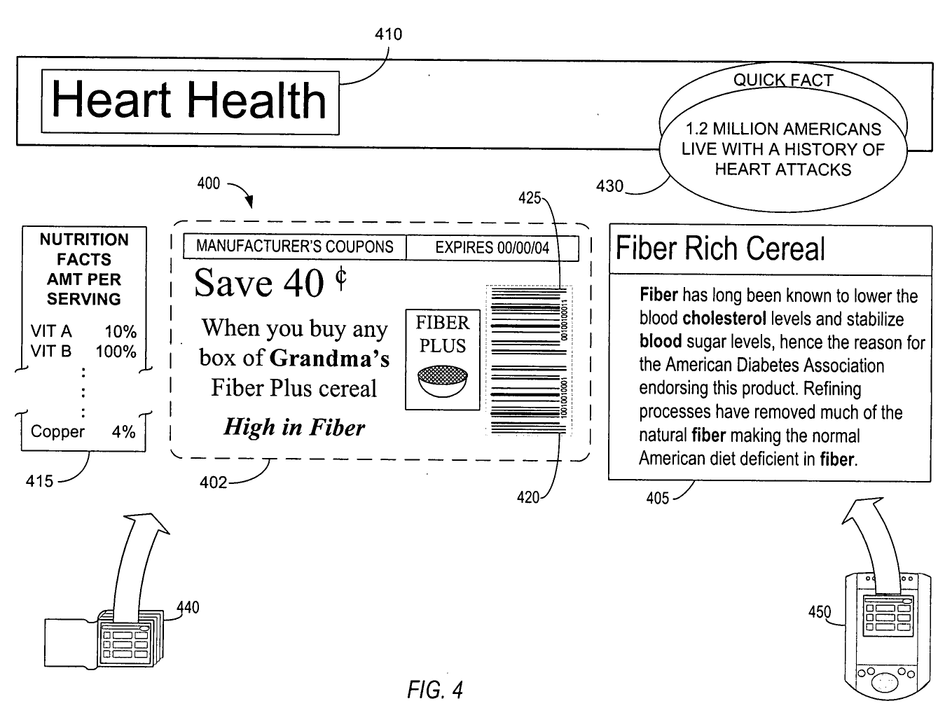

FIG. 1 comprises blocks representing one or more affiliated stores and a service provider operating to provide a service to consumers based, at least in part, on their purchases from the stores. FIG. 2 provides a broad and easily understood flow diagram of the data collection and processing method used to generate a collection of information and possibly written material for the consumer. FIGS. 3A and 3B add additional details to the flow diagram of FIG. 2. FIGS. 4, 5 and 6 present graphically the way some of the information, generated by the process of FIG. 2, is presented in one or more screens or pages of the material that are provided to the consumer.

Referring now to FIG. 1, a designator 100 refers to one or more stores wishing to provide consumers with helpful information relative to their food purchases. A block 105 represents a store computer connected to one or more scanners 110 normally situated in proximity with the checkout registers. As data is obtained from the scanners, it is transferred to an in-house database storage device 115. Although not shown, it will be recognized by those skilled in the art, that in the computer 105 there will be the capability of entering data into the database storage 115 by manual or voice operation independent of the scanners 110. Food consumers 1 through N of the store(s) 100 are generally represented by a designator 120. A service provider 125 operates to interface between the stores 100 and the consumers 120. As shown, there is another computer 130, a storage device 135 for programs and a database and a printer 140. While any printing involved in this process may be provided directly by the service provider 125, it may also alternately be provided by outside sources under the control of service provider 125. A source of reference data is represented by a block 145. A network 150 is interconnected with the store(s) 100, the consumers 120, the service provider 125 and the reference data block 145 for providing communication therebetween. This network can comprise any communication system or combination of systems including telephone, wireless network or link, internet and the like.

In FIG. 2, a block 200 represents transactional POS (point of sale) collected data, typically including customer ID, sales receipt data, store IDs, UPC data, produce codes, time stamps and so forth. This data will typically be collected in connection with passing food and/or a loyalty card over a scanner 110. The data obtained is stored in memory or long term storage on-site such as database 115. A block 205 represents one or more types of information or data that might be obtained or otherwise collected in connection with applying for a store loyalty card, including customer name, address, loyalty card customer ID and other appropriate customer attributes, such as names and ages of all family members for which the customer is purchasing food. Block 205 may well include customer specific data such as whether or not there are one or more vegetarians in the family unit, pets and so forth. Block 205 may also comprise collected health data such as a consumer having diabetes or high blood pressure.

A block 210 represents a database of consumer provided supplemental data not originally included in the data obtained in connection with loyalty card purchases. Such supplemental data may include food purchases made from other stores not connected to the present service provider operating the present invention. The supplemental data may further include information such as the fact that the consumer purchased food at the loyalty card store or elsewhere for a party attended by X number of individuals. Other supplemental data may involve the addition or subtraction of a given number of family members on a permanent or semi permanent basis. This supplemental information may be supplied to the service provider 125 directly or to the store database 115 through the internet, telephone or in writing for manual entry by the entity controlling the database within block 210.

A block 215 represents a database comprising collected product nutrient data for each store UPC including produce codes.

Information obtained in the data collecting steps of blocks 200, 205, 210 and 215 are supplied to a block 220. Block 220 represents a data processing portion of a computer program run by the service provider 125. This portion of the program and system operates to cross-correlate and compile a database of products purchased and their associated nutrient values for each store customer using a loyalty card and agreeing to be apprised of health related information in connection with their purchases. The information obtained from the various sources may be adjusted in value or even ignored based upon exceptions that need to be considered as shown by a block 222. An example or such an exception might be where the calcium utilized by a given consumer is dependent upon whether that consumers' diet is high or low in animal protein. The database generated in connection with block 220 is stored in some form of memory, such as 135, shown by block 225.

A block 230 represents a database of dietary reference tables. Tables used in a preferred embodiment comprised RDA (recommended daily allowance) data as well as food exchange data. Information from blocks 215, 225 and 230 is combined, or otherwise processed, to generate a bill of health as set forth in a block 235.

The next step in the process, set forth in a block 240, is to prepare a collection of electronic data or a packet of material including coupon, group commonality health related data, facts and educational material and consumer specific health related data such as the BOH in some format. The term “group commonality health related” as used herein is intended to refer to a group of consumers having a common health related problem such as diabetes, high blood pressure, osteoporosis, high cholesterol and so forth. The data associated therewith may be a simple statement of fact such as “Did you know that roughly 41 million Americans are considered to be at ‘high risk’ with their existing cholesterol levels”. Another simple statement of fact is presented in FIG. 4, to be later discussed, as a “QUICK FACT”. Conversely, the data may comprise full page (electronic or hard-copy), multi-paragraph educational articles on subjects such as “Understanding Factors Contributing to the Onset of Diabetes” or “What is the Atkins Diet”. However, the term “group commonality” can also be used to designate a group of people that have indicated in steps 205 or 210 that they have a commonality that is not necessarily health related such as being vegetarians.

In a preferred embodiment, at least a majority of this material will be in the form of a booklet. The booklet can be in the form of an electronic format display or in the form of a printed pamphlet. If in electronic format, any coupons in the booklet that a consumer wants to redeem can be printed on a printer attached to an electronic display device used to view the booklet. By an electronic display device, I am referring to items such as a personal computer, a PDA (personal digital assistant), a cell-phone and so forth. Alternatively, a coupons' UPC (universal product code) can be read directly from the LCD (liquid crystal display) screens of present day computers by some UPC scanners. Another way in which a coupons' UPC code can be transferred to a store computer, such as 105, in accordance with the process step outlined in block 200, is by infrared or LED (light emitting diode) signals transmitted to equipment at the sales receipt data site. Further, if the booklet, for a given consumer, is to remain in an electronic format, the last step, shown as block 245, can comprise sending the data signals electronically to the consumers electronic display device over network 150.

The consumer, to whom the consumer specific booklet is to be delivered, can require that the material be supplied in printed format. Step 240 would cause the booklet to be printed and delivered to the consumer as set forth in block 245. In a preferred printed embodiment, the step of block 240 would include causing perforations around the coupons for ease of removal of the coupons from the booklet.

Additionally, the content of the booklet 440 or collection of information produced may optionally be customized in a number of ways by the consumer to whom a specific booklet is to be delivered. For example, such customization comprises selecting or requesting omission of coupons for one or more food products (e.g., orange juice, oranges, chicken soup stock, chicken soup, etc.), food product types (e.g., fresh vegetables, frozen vegetables, juices, frozen juices, cereals, etc.), providers (e.g., brand names, manufactures, sponsors, endorsers, etc.) and the like, as is desired. Such customization also comprises additionally or alternatively, selecting or requesting omission of articles or other information provided by one or more entities (i.e., authors, manufacturers, organizations, sponsors or endorsers, etc.) or concerning one or more subjects (e.g., exercise, diet, heart disease, obesity, diabetes, etc.), and the like, as is desired.

The booklet 440 or collection of information would be prepared with reference to data representing such customization indication of the consumer. For example, the booklet or collection of information would be prepared to provide the consumer with only those coupons and articles selected and/or more of the same than would otherwise have been provided. Conversely, the booklet 440 or collection of information would be prepared with reference to consumer customization instructions, to provide the consumer with no coupons or articles requested to be omitted and/or less of the same than would otherwise have been provided.

For the edification of those interested, a more detailed block diagram of the process presented in FIG. 2 is provided in FIGS. 3A and 3B. Many of the blocks illustrated are enclosed by dash lines where the dash line enclosures have the same designator as used in FIG. 2 and constitute substantially the same function as mentioned in connection with FIG. 2. Other blocks such as 225 and 235 are directly representative of the same function in both FIGS. 2 and 2B. A previously undesignated function of redemption tracker is given a designation of 305. This function operates to allow the service provider 125 to track the POS data to present a full cycle view of the coupon redemption rate obtained in one or more distribution cycles. The coupon IDs are captured at the POS level 100 and sent back with each data export from the retailer 100 or store data center to the service provider 125.

Referring now to FIG. 4, there is shown a data token in the form of a coupon 400, within dash lines 402. One or more, of these coupons 400, will typically be displayed in a portion of a page in or comprising a packet of material delivered to a consumer. If the packet of material is in printed format, it may take the form of 440. If it is supplied in electronic format for display, it can take the form shown on a PDA 450. The coupon 400 is a cost-saving, discount coupon for 40 cents off a box of GrandMa's Fiber Plus cereal, a fictitious cereal brand used as an example. The coupon 400 is preferably displayed in color to positively enhance the reading or viewing process, however, the coupon 400 could also be monochromatic. While the coupon 400 is shown displayed on a page, it will be appreciated by those skilled in the art that any other token could be used, such as that displayed on the screen of a personal computer (PC) or smart card, as well as other devices and materials in a manner similar to PDA 450.

FIG. 4 also illustrates other displayed information or data grouped on a coupon page of the packet of material 440 that would be delivered to a consumer. Displayed within a block 405 is educational information and data about why the general type of product, to which the adjacent coupon refers, is beneficial to an individual's health. This particular example coupon 400 is displayed in a section of the packet or collection of consumer-specific material 440 directed to heart health, as shown within a block 410. The material in block 405 promotes heart health by informing the consumer, for example, that fiber is beneficial to one's heart.

A block 415 displays a listing of pertinent nutritional facts as presented on a container of the product promoted for purchase by the coupon 400. Only a partial listing is shown in FIG. 4. The coupon 400 also contains space to display two electronically readable or scan-able universal product codes (UPC) 420 and 425. One of these codes provides information or data such as a coupon identifier, manufacturer identification (ID), family code, value code and a check digit. The other UPC code provides further information or data relevant to the promotion being offered such as an offer code, a household ID, expiration dates of the coupon and other identifiers. With this information, the use of a coupon can be tied to the success of a given manufacturer or store advertising campaign. Other scanned codes, or additional consolidation of information or data in the codes shown, may also be set forth on the coupon area of the display to enhance future advertising campaigns.

A designator 430 references an educational quick fact that is related to the “Heart Health” section of the consumer packet as set forth in block 410. Other coupon sections may be presented under categories such as Calorie Management, Vitamins, Weight Management, Minerals, Well Being and so forth. In a printed embodiment, the area around coupon 400, substantially coincident with the dash line, can comprise perforations in the page to facilitate easy removal of the coupon 400 without destroying or otherwise mutilating the rest of the page.

Other pages in the material periodically distributed to the consumer may include recipes that may further advantageously comprise a nutritional facts listing for the food product produced in accordance with the recipe. Such nutritional facts listings may also be provided for other products displayed within each packet of material. Various other educational information relating to diets, minerals and so forth, may also be displayed along with advertising of the stores, manufacturers, organizations or other entities associated with generating and distributing the consumer specific material. This collection of product information, one or more discount coupons and customer-specific purchasing information, as described above, is displayed in the form of booklet. The term customer-specific information as used herein includes any summaries of information pertaining to the nutrients purchases by a given or specific customer in a given time period covered by the distributed material. It will be appreciated by those skilled in the art that any other token could be used, such as that displayed on the screen of a personal digital assistant (PDA), personal computer (PC) or smart card, as well as other devices and materials.

Reference should now be made to FIG. 5 where two minerals (calcium and iron), comprising a portion of a BOH (bill of health) 500, are displayed in a block or section designated as 505. A section 510, displays the average Mgs (milligrams) consumed per family member, as shown by the data collected by seller 100, in a given period of time. A block or section 515 displays the amount in Mgs recommended by the United States Department of Agriculture (USDA). As will be realized, a complete BOH 500 would typically have many more minerals and vitamins and would preferably include all updated RDA's posted by the USDA.

The BOH 500 comprises a display of a collection of consumer-specific data or information reflecting one or more types of data relating to purchases by the consumer. The BOH 500 typically displays data directly related to the nutrients found within a consumer's total food purchases within a specified period, preferably such as a month. In addition, the BOH displays corresponding recommended daily allowances of nutrient values provided by USDA

The general purpose of the BOH is to notify an individual consumer of nutrient deficiencies (or excesses) of their existing food purchasing behavior by displaying positive or negative variances of the actual values of total nutrients purchases from the RDA's as posted by the USDA. It will be appreciated that this could alternatively be a simple comparison between the total monthly intake and the total value recommended by the USDA for one consumer over the monthly period.

Each statement or analysis will typically contain the participating consumer name, address, personal nutritional summations and so forth. An added feature is the optionally provided ability for the consumer to access their account and profile via a communication path such as telephone, fax, an internet/online interface and the like. This was shown as step 110. This will allow individuals to place their own food items into their own profile for foods that have been purchased at a grocery store operating outside the scope of the service herein provided.

Shown in FIG. 6 is a vertical line or bar graph, depicting the amounts of a given nutrient, such as calcium, that the consumer received in the period represented by the booklet from a given number of food type sources purchased such as the top 10 sources. The calculation of these amounts takes place in the step of block 237. The bars in the graph displayed are identified as Items A through J, representing purchased food items such as milk, cheese, kale, almonds, Brazil nuts, dried figs, oatmeal, parsley, black molasses, okra, collard greens and so forth.

As is known, animal protein (beef, poultry, fish, and egg) causes calcium to be excreted in the urine. Therefore a person following a diet that does not include animal protein may have lowered calcium needs. For example, a person consuming a low protein, low sodium diet may only need as little as 500 mg of calcium daily. On the other hand, a person consuming a high protein, high sodium diet may need as much as 2000 mg of calcium per day. Thus in presenting the recommended values in the table of FIG. 5 and in preparing the graph of FIG. 6, exception rules, purchasing habits, dietary considerations and so forth must be taken into consideration and used to adjust the values presented in the chart 500. Also, the apparent intake of a given nutrient by the consumer as well as amount of the nutrient required must be adjusted on a per consumer basis in the exception rules. This must be done in order to accurately inform the consumer where the consumer may have excesses or deficiencies in the eating habits of that consumer.

In summary, POS data is collected from each purchase of food products. A packet, booklet 440 or display 450, displaying a collection of information or data is generated and delivered, specific to each involved consumer. The packet, booklet 440 or display 450, comprises a display or presentation of information, set forth herein as a BOH 500, showing where the consumer's purchases may well lead to a deficiency of certain minerals and vitamins as determined by the USDA and/or other sources. The BOH 500 can show nutritional totals and/or can show totals adjusted by a consumer's dietary habits. The packet, booklet 440 or display 450, comprises one or more coupons 400 that can be used to help correct the deficiencies indicated in the BOH or to achieve specific personal health and nutrition related objectives, such as dealing with diabetes or being a vegetarian. Since nutritional deficiencies, and even certain excesses such as to much Vitamin A, are detrimental to one's health, the process provides a consumer with a convenient way to improve their nutritional intake.

The process may also be used to monitor specific dietary needs relevant to specific functions such as obesity, diabetes and so forth. The process shown enables manufacturers to reach targeted consumer more effectively with coupons, promotions and other consumer related advertising. As an example, advertising for meat products could be deleted from consumers known to be vegetarians. If it is further known that the vegetarian consumer is deficient in calcium, a coupon can be included for a recently introduced calcium supplement. The consumer information database 115 may be designed to include information such as whether the consumer is a vegetarian, has certain dietary preferences or health conditions, such as requiring low sodium alternatives, that may be advantageously utilized in inserting coupons for given products in a given consumers packet or booklet.

The collection of data and information mentioned above may be displayed in any format (also referred to as “information collection display”), such as in an electronic display (e.g., a computer, PDA or television screen and the like), a printed display (e.g., in hard copy) or other. Such a collection of information, when in printed format, is preferably provided in a substantially square booklet of 7 inches by 7 inches. The term booklet as used herein is deemed to include the consumer's material packet whether or not the data is presented in a booklet format or electronic display. If in printed booklet format, the pages may be stapled together, bound or presented in loose leaf format. The electronic display of information can take the form of one or more screens of a personal computer, PDA, television and the like. An electronic page comprises any screen display that can be accessed continuously by scrolling.

The program and system used to generate the BOH 500 in block 135 can further account for “leakage,” where leakage is defined as the difference between a consumer's grocery purchases and the actual amount of food consumed. This may be accomplished by the supplemental data supplied as set forth in block 210 of FIG. 2. In addition, information obtained from nutritional research, may be used to adjust apparent values in accordance with predefined algorithms.

Through the use of this invention, an enhanced relationship and sharing of beneficial information between manufacturers, grocers, marketers and a service provider is obtained to enhance the well-being and health of consumers. While a store or other merchant with a sufficient number of customers that shopped for food only at that store could practice this invention, most stores would not have the inclination, time or expertise. Thus typically a service provider 125, such as the assignee of the present invention, will contract with a plurality of stores, chains and so forth. The service provider 125 can advantageously compile data collected from a plurality of stores, generate a finished product and distribute it to consumers.

As mentioned in connection with FIG. 6, the information and data included in the booklet 440 or display 450, may further comprise one or more tables illustrating the sources of a predetermined number of one or more of the vitamins or nutrients listed in the bill of health 500 as shown in FIG. 6. This information will allow a consumer to more easily determine where and what foods to additionally consume, or reduce the consumption of, as related to a specific one or more nutrients or vitamins in that consumers diet.

Although the invention has been described with reference to a specific embodiment, the description is not meant to be construed in a limiting sense. Various modifications of the disclosed embodiment, as well as alternative embodiments of the invention, will become apparent to persons skilled in the art upon reference to the description of the invention. It is therefore contemplated that the claims will cover any such modifications or embodiments that fall within the true scope and spirit of the invention.

1. A method comprising:
gathering data indicative of at least one of an activity, a trait and an attribute common to a group of people;
filtering said data to obtain a selected portion of said group of people;
preparing an information collection displaying at least the following:
at least one product coupon redeemable for a discount in the purchase of a product;
one or more nutritional attributes of the product or type of product for which the coupon can be redeemed; and
distributing the packet or data display to said selected portion of said group of people.

2. The method of claim 1 wherein:
the information collection display additionally comprises at least one of the following:
educational presentations;
health benefit analysis of one or more products identified within said information collection;
product advertising;
food recipes;
provisions for feedback from recipients to an entity distributing said sales material; and
an index for various categories of products.

3. The method of claim 1 wherein:
said information collection display is sectionalized into different product categories and wherein at least two of said categories are related to heart health, calorie management, vitamins, weight management, minerals, children, allergies, natural, organic, women's health, men's health or well-being.

4. A nutrition and health directed information collection display for distribution to a group of people having a commonality of attributes, comprising:
information and data pertaining to nutritional and/or health related products at least some of which can be obtained at a discount through the use of associated coupons comprising a part of the information or data display; and
an individualized listing of nutritional deficiencies in the diet of the parties to which the information or data display is distributed wherein the information utilized in preparing the individualized listing of nutritional deficiencies is obtained from one or more entities selling nutritional products to said group of people.

5. The information collection display of claim 4 comprising, one or more graphical displays of at least some of the primary sources of at least one of the nutrients listed as being deficient.

6. A health-related information package for distribution to a group of people having a commonality of attributes, comprising:
educational information related to one or more health topics;
a coupon redeemable for one or more benefits associated with the purchase of a products related to said commonality of attributes; and
data representing the nutrient content of goods purchased by a consumer that is a member of the group.

7. An information collection display comprising:
one or more electronic or hard copy pages comprising health and nutritional information; and
one or more electronic or hard copy pages, wherein each of said pages displaying one or more coupons redeemable for a discount in the purchase price of a specified product at a product sale location; and
wherein each of said pages displaying said coupon also displays information indicating one or more health benefits associated with the specified product.

8. The information collection display of claim 7, further comprising:
one or more electronic or hard copy pages setting forth consumer specific nutrient deficiencies derived at least in part from data reflecting food product purchases by the consumer; and
one or more electronic or hard copy pages displaying recipes for healthy food consumables using one or more of said products specified by one or more of said coupons.

9. The information collection display of claim 7, further comprising:
one or more electronic or hard copy pages displaying nutritional data relating to said product specified by one or more of said coupons.

10. A consumer specific informational packet comprising:
one or more displays of health and nutritional facts;
one or more pages comprising a cost saving entitlement coupon redeemable at specified sales locations and further comprising data indicating one or more health benefits associated with consumption of the product; and
one or more pages setting forth consumer specific nutrient deficiencies derived from data representing one or more purchases made by the consumer at one or more of the specified sales locations at which the coupon is redeemable.

11. A method comprising:
providing a customer with a loyalty card for a given merchant;
storing data identifying the customer and the loyalty card;
storing data representing authorization from the customer to collect and store data representing products purchased by the customer from the given merchant in conjunction with the loyalty card;
collecting and storing purchased product data representing one or more products purchased by the customer;
associating the purchased product data with one or both of the data identifying the customer and data identifying the loyalty card;
deriving a bill of health table at least in part from purchased product data associated with one or both of the data identifying the customer and data identifying the loyalty card; and
providing the customer with the data representing the bill of health table.

12. The method of claim 11, further comprising:
obtaining, directly from the customer, supplemental data representing product purchases made from merchants other than the given merchant; and
wherein the step of deriving further comprises deriving the bill of health table at least in part from the supplemental data representing product purchases made from merchants other than the given merchant.

13. A method of generating a BOH (bill of health) for a consumer comprising:
assembling a food purchase database of UPC (universal product code) food purchases over a given period of time by a given consumer upon presentation of a loyalty card in connection with each food purchase;
retrieving additional data representing one or more food purchases by the given consumer without presentation of the loyalty card;
maintaining a nutrient quantity database of nutrients contained in each of the UPC code products;
calculating total quantities of each of a given plurality of nutrients as obtained from said food purchase database as cross referenced to said nutrient quantity database; and
generating a listing of recommended quantities of each of said given plurality of nutrients along with actual quantities consumed as determined from the food purchase database as adjusted by the additional food purchase data provided by the consumer.

14. A method of generating a consumer specific BOH (bill of health) comprising:
scanning food purchases by a plurality of consumers at a store;
maintaining a database of the scanned data pertaining to food purchases by each of the plurality of consumers;
maintaining a database of attributes of each of the plurality of consumers;
generating, periodically, consumer specific nutritional information for each of the plurality of consumers that have recently purchased food at the store;
preparing a display of information comprising the consumer specific nutritional information; and
distributing the display to the respective ones of the plurality of consumers.

15. The method of claim 14 wherein the display of consumer specific nutritional information comprises a bill of health.
